(19) United States
(12) Patent Application Publication
(10) Pub. No.: US 2006/0109534 A1
(43) Pub. Date: May 25, 2006

(54) Ultra-flat reflective MEMS optical elements

(75) Inventor: Thomas J. Grebinski, Alamo, CA (US)

Correspondence Address: HAYNES BEFFEL & WOLFELD LLP, P O BOX 366, HALF MOON BAY, CA, 94019, US

(73) Assignee: Micronic Laser Systems AB, Taby (SE)

(21) Appl. No.: 11/264,361

(22) Filed: Nov. 1, 2005

Related U.S. Application Data
(60) Provisional application No. 60/623,928, filed on Nov. 1, 2004.

(51) Int. Cl. G02B 5/32

(52) U.S. Cl. 359/15

(57) ABSTRACT

The present invention relates to producing ultra flat micro surfaces suitable, for instance, for micro-mirrors. In particular, it relates to low pressure chemical mechanical planarization (CMP) of a partially cured sacrificial layer.

### RELATED APPLICATION

This application claims the benefit U.S. Provisional Patent Application No. 60/623,928 filed on Nov. 1, 2004. The provisional application priority document is incorporated by reference.

### BACKGROUND OF THE INVENTION

The present invention relates to producing ultra flat micro surfaces suitable, for instance, for micro-mirrors. In particular, it relates to low pressure chemical mechanical planarization (CMP) of a partially cured sacrificial layer.

Use of micro-mirrors in a diffractive intensity control mode is a rarified field of research. Micronic Laser, AB of Sweden has pioneered use of micro-mirror arrays in a diffractive mode to produce intensity patterns that carefully designed optics translated into images. By diffractive mode, we mean that destructive interference between components of the radiation relayed by reflective elements produces diffractive effects. A one-quarter wavelength difference in height between opposing edges of a micro-mirror or between adjoining micro-mirrors produces a one-half wavelength difference in how far the relayed radiation travels. This one-half wavelength difference, under ideal conditions, produces total extinguishment of the relayed intensity along an axis perpendicular to the micro-mirror, which is known as the zeroth-order component. The energy of the relayed radiation is disbursed along other non-perpendicular axes, which are removed from the beam before an image is formed.

Diffractive intensity control depends on the phase relationship of adjacent relayed radiation components, instead of deflection. Most popular mirror arrays or vectors, for instance those used in projectors, modulate intensity by controlling how long the mirror deflects light along the transmission axis, as opposed to how long the light is deflected out of the transmission path. Illumination in a particular area of the resulting image flashes on and off much faster than the eye can detect. The proportion of the time that the particular area is illuminated determines how bright it appears to the eye. Deflection of a mirror operating in deflection mode is measured in degrees or fractions of a degree, instead of fractions of one-quarter of a wavelength of illuminating radiation. Manufacturing precisions that are well-suited to deflection operation may not meet the more demanding requirements of diffractive mode operation.

Building ultra-flat micro-mirrors is different from building other ultra-flat structures because the micro-mirrors are very small and very thin. One micro-mirror array that benefits from application of this technology includes 1 million reflective elements, in a 512×2048 array, individual elements measuring 80 nm on a side. The micro-mirrors are much thinner than they are wide or tall. Thin structures are vulnerable to curl, once the micro-mirrors of an array are released to operate under individual control. Different manufacturing methods are required for this size of structure than for larger structures, such as a camera lens.

An opportunity arises to develop manufacturing methods that produce ultra-flat micro-surfaces, including reflective elements or micro-mirrors well-suited for use in a diffractive mode spatial light modulator (SLM) array. Better, more easily calibrated and more durable components and systems may result.

### SUMMARY OF THE INVENTION

The present invention relates to producing ultra flat micro surfaces suitable, for instance, for micro-mirrors. In particular, it relates to low pressure chemical mechanical planarization (CMP) of a partially cured sacrificial layer. Particular aspects of the present invention are described in the claims, specification and drawings.

### BRIEF DESCRIPTION OF THE DRAWINGS

FIG. 1 illustrates a micro-mirror.

FIGS. 2-4 illustrate build-up of a sacrificial layer and a structure layer over the sacrificial layer.

### DETAILED DESCRIPTION

The following detailed description is made with reference to the figures.

Preferred embodiments are described to illustrate the present invention, not to limit its scope, which is defined by the claims. Those of ordinary skill in the art will recognize a variety of equivalent variations on the description that follows.

At the leading edge of reflective optical imaging technology is a requirement that the reflective elements be very planar or flat. If the reflective elements, commonly referred to as mirrors, are not planar the bright intensity of the mirrors, with no deflection, will be less while the dark intensity increases. Furthermore, for certain out-of-plane mirror shapes, such as a cylinder substantially curved perpendicular to the axis of movement of the mirror, there is an undesirable imaginary contribution to the complex amplitude of the contrast curve.

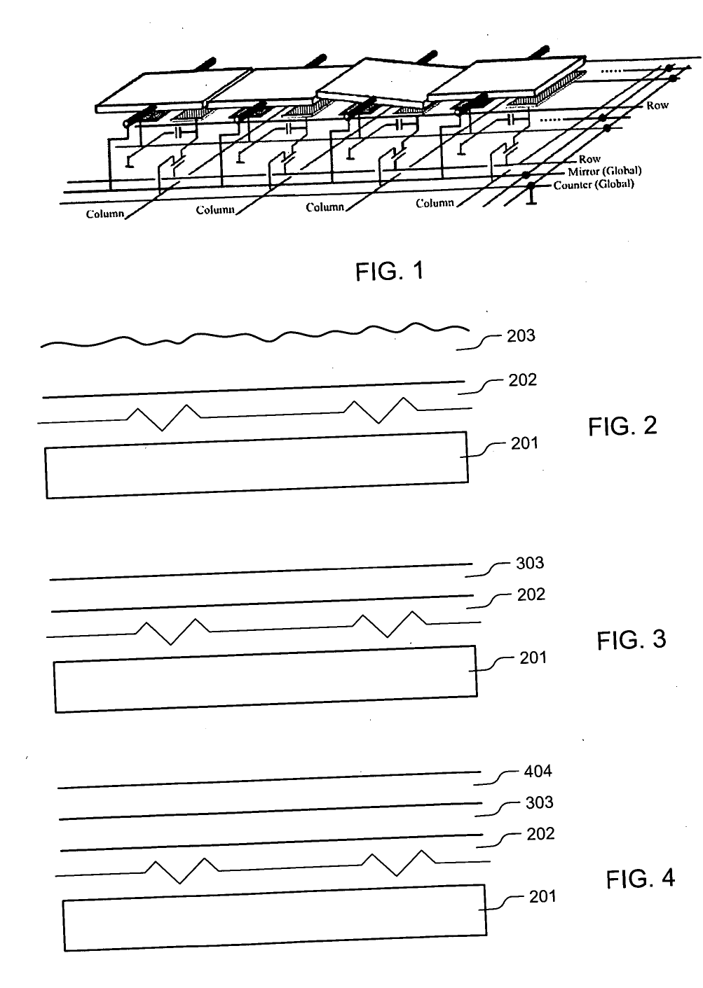

FIG. 1 depicts a layout of four CMOS and MEMS pixel cells with wriing for individual addressing, global counter electrode addressing and global mirror electrode addressing. From this conceptual layout, one of ordinary skill in the art will recognize the architectures of mechanically actuated micro-surfaces. These surfaces may include center hinged, edge hinged or even piston actuated surfaces.

Mirror shape and performance can be improved when a sacrificial substrate is formed using low membrane and retaining ring downward forces for CMP, along with mirror-forming polyimide sacrificial layers heat-treated at temperatures less than the curing temperature, yield scratch-free, ideally planar, polyimide surfaces suitable for the manufacture of movable micro-mirrors with optimized bright intensity, lower dark intensity and a minimized imaginary contribution to the complex contrast amplitude.

For some movable micro-mechanical optical elements, the reflective and structural means of the movable micro-elements are formed on top of a patterned sacrificial layer such as photoresist or polyimide. Both types of sacrificial layers offer various advantages to the performance of the mirrors but not enough performance for some of the more recent applications of optical MEMs technology to mask-based and direct-write laser pattern generation in the semiconductor industry. The repeatable exactness needed for the creation of an image a few nanometers in size and its equally repeatable placement over vast areas of a flat plate, begs for a optical MEMs technology that surpasses the capabilities offered by certain sacrificial layer fabrication technology. With a resist sacrificial layer process there are localized planarity issues. With today's polyimide CMP processes there are issues with the quality of the polished film after the CMP process; there are too many scratches. Both methods and their drawbacks are described below.

One prior method used to construct relatively flat reflective optics was through the deposition of a reflective thin film onto a relatively planar, patterned, photoresist sacrificial layer whose pattern defined the shape and structure of the resulting reflective optical elements. Although the resist layer was relatively scratch-free there was a significant drawback to the development of the pattern, planar, surface that causes the planarity to be less than optimal and less than what is needed. In order to optimize the planarity of the resist, there necessarily needed to be a second thermal process whose purpose was to cause the resist to flow and thus make the surface more planar; flatter. Although generally, the surface of the resist was more planar, the local planarity near the edges of the pattern worsened. The nonplanar rise of the resist at the edge of the pattern caused the reflective optic to rise at the edges as well. The resulting optical performance of such non-planar reflective optics was considered too low to be acceptable; a more planar surface was needed.

A novel method uses a polyimide thin film instead of resist. The film, such as a non photosensitive material from Crystec Technology Trading GmbH, is spun onto the wafer just as is resist. Unlike the resist, the polyimide thin film is cured at elevated temperatures to initiate and complete what is called an imidization process. The temperatures of the heat treatment depends on the type of polyimide but can be 400 degrees Celsius or higher. Alternatively, a photosensitive polyimide material might be used. See http://www.crystec.com/kllpixe.htm. The cured polyimide is then planarized by chemical mechanical polishing (CMP) and the pattern is placed in the planarized polyimide by a photolithography, etching and then a stripping process. The resulting planarized and patterned thin film is nearly ideally flat. Some CMP processes produce scratches in the planarized polyimide surface that was traced back to the fact that the polyimide film was relatively inert to the chemical portion of the polyimide CMP process and the fact that the downward pressures of the retaining ring and membrane on the wafer, during the polyimide CMP process, were too high. The scratching problem, if observed, can be overcome by thermally treating the polyimide film prior to CMP at lower temperatures than the curing temperature (below the complete imidization temperature/pressure/time) and the retaining ring and membrane downward pressures are less than or equal to 3 lbs each. Taken together, the planarity of the patterned sacrificial layer used to define the surfaces and the structure of the mirrors was favorably optimized and virtually scratch free.

FIGS. 2-4 illustrate certain steps of one embodiment. FIG. 2 depicts initial application of a sacrificial layer 203 over one or more device formation layers 202 over a substrate 201. Not illustrated is the partial polymerization of the sacrificial layer, described above. This illustration has been omitted, because partial imidization thins the layer. FIG. 2 is conceptual, not to scale, so the illustration would not change noticeably as a result of partial imidization. In FIG. 3 the sacrificial layer has been planarized 303 to produce an essentially scratch free surface. Either because of the choice of sacrificial substance combined with low polishing pressure or partial curing of the sacrificial substance combined with low pressure polishing produces this essentially scratch free surface. Not illustrated is completion of polymerization of the sacrificial layer, described above. This illustration has been omitted, because completion of imidization leaves the layer essentially scratch free, as illustrated. In FIG. 4, one or more layers 404 are added over the planarized sacrificial layer 303. In a micro-mirror embodiment, a reflective layer may be formed directly over the sacrificial layer 303 or a structural layer may be directly over the sacrificial layer and the reflective layer may be over the structural and sacrificial layers. Not illustrated is patterning of the layers 404 and removal of the sacrificial layer 303. This is not illustrated, because of the variety of patterns that could be chosen for these layers. Note that while the sacrificial layer 303 is illustrated as continuous, most designs of a structural layer 404 over another structural layer 202 or 201 will include posts or other supports that protrude through the sacrificial layer. This will be readily understood by one of skill in the art, as the layers 404 cannot float unsupported after the sacrificial layer 303 is removed.

While the present invention is disclosed by reference to the preferred embodiments and examples detailed herein, it is understood that these examples are intended in an illustrative rather than in a limiting sense. Computer-assisted processing is implicated in the described embodiments. Accordingly, the present invention may be embodied in methods for calibrating an SLM, systems including logic and resources to carry out calibration of an SLM, media impressed with logic to carry out calibration of SLM elements, or data streams impressed with logic to calibrate SLM elements. It is contemplated that modifications and combinations will readily occur to those skilled in the art, which modifications and combinations will be within the spirit of the invention and the scope of the claims. A variety of devices carrying out the methods are further envisioned.

We claim as follows:

1. A method of producing an ultra-flat surface overlying a sacrificial substrate, the sacrificial substrate including a polyimide thin film, the method including:
thermal partial imidization of a polyamic acid film, wherein at least a portion but not all of the polyamic acid film has been imidized into polyimide;
chemical mechanical polishing of the partially imidized film; and
thermal final imidization of the polished partially iminized film.

2. The method of claim 1, wherein a downward force between a substrate to which the partially imidized film is applied and a polishing platen is less than or equal three pounds per square inch.

3. The method of claim 1, further including:
forming a layer over the polished and finally imidized film; and
patterning the layer and removing the polished and finally imidized film to form a structure.

4. The method of claim 2, further including:
forming a layer over the polished and finally imidized film; and
patterning the layer and removing the polished and finally imidized film to form a structure.

5. The method of claim 3, wherein the structure has a surface area of 6400 sq. nm or less.

6. The method of claim 4, wherein the structure has a surface area of 6400 sq. nm or less.

7. A method of producing an ultra-flat sacrificial substrate underling a reflective optical element that is formed through the deposition of a reflective thin film, the sacrificial substrate including a polyimide thin film, the method including:
forming a partially imidized film;
chemical mechanical polishing of the partially imidized film;
converting the polished partially iminized film to a polyimide film; and depositing a reflective material over the polished polyimide film.

8. The method of claim 7, wherein a downward force between a substrate to which the partially imidized film is applied and a polishing platen is less than or equal three pounds per square inch.

9. The method of claim 7, further including:
patterning the reflective material and removing the polished polyimide film to form a structure.

10. The method of claim 8, further including:
patterning the reflective material and removing the polished polyimide film to form a structure.

11. The method of claim 9, wherein the structure has a surface area of 6400 sq. nm or less.

12. The method of claim 10, wherein the structure has a surface area of 6400 sq. nm or less.
